(19) United States
(12) Patent Application Publication
(10) Pub. No.: US 2009/0314770 A1
(43) Pub. Date: Dec. 24, 2009

(54) Dual susceptor temperature controlled resin composition for inductive control heating and method of use

(76) Inventors: Drew P. LaMarca, Whippany, NJ (US); Brayan Agosto, North Bergen, NJ (US); Tom Zich, Vernon, NJ (US); Jim Burke, Mahwah, NJ (US)

Correspondence Address: Klaus P. Stoffel;Wolff & Samson, One Boland Drive, West Orange, NJ, 07052, US

(21) Appl. No.: 12/214,502

(22) Filed: Jun. 19, 2008

(51) Int. Cl. H05B 6/06; H05B 6/10

(52) U.S. Cl. 219/633; 219/634; 156/272.4; 219/667

(57) ABSTRACT

A dual susceptor composition with a resin matrix formed of at least one polymer or thermoset material and magnetic or electrically conductive particles, and an inductive material structure laminated with or encapsulated by the resin matrix.

### BACKGROUND OF THE INVENTION

The present invention relates to polymer induction bonding. Such bonding is used to encapsulate, weld, forge, bond or set polymer materials. More particularly, the invention relates to a dual susceptor temperature controlled resin composition for inductive control heating.

Induction bonding is a known process for bonding together polymeric materials by mixing ferromagnetic particles of particular compositions in the polymer to be heated. Temperature control is generally obtained by selecting ferromagnetic particles with specific Curie temperatures.

Current materials used for such bonding are made from a plastic polymer compounded with magnetic particles and heated through an electrical induction energy frequency at a fixed KHz to MHz single frequency. The material is manufactured as pellet and solid profile material. Inductive heating efficacy losses are present with the known welding material due to the particle size and amount contained in the compound polymer matrix. The size of the material pellet, as well as location relative to the magnetic field and profile also limits the fusion process in the assembly.

Various types of materials are known for induction bonding. For example, U.S. Pat. No. 6,048,599 discloses a sheet material for electromagnetic fusion bonding which comprises a plurality of composite electromagnetic portions including susceptor particles uniformly distributed adjacent polymer portions. The composite portions are bonded to each adjacent polymer portion so that the composite portions and the polymer portions form a patterned array of alternating portions.

U.S. Pat. No. 6,056,844 discloses controlled-temperature induction heating of polymeric materials by mixing ferromagnetic particles in the polymer to be heated. Temperature control is obtained by selecting ferromagnetic particles with a specific Curie temperature (Tc). The ferromagnetic particles heat up in an induction field, through hysteresis losses, until they reach their Curie temperature (Tc). At that point, heat generation through hysteresis loss ceases.

U.S. Pat. No. 6,939,477 discloses a temperature-controlled induction heating of polymeric materials wherein an induction coil, which generates a magnetic field, is placed near the material and heats a susceptor, such as a metal screen or powder, within the material to be heated. To improve the induction heating process, the susceptor design is optimized for effective fusion bonding or welding of thermoplastic layers, the method of mixing or placing the susceptor particles within a composite matrix is optimized, and the power infrequency of the induction device are optimized.

U.S. Pat. No. 5,643,390 discloses bonding techniques for high performance thermal plastic compositions in which a thermoplastic material and a thermosetting monomer are selected so that the thermosetting monomer has similar solubility parameters to the thermoplastic material. The thermoplastic material is bonded directly to the surface of the thermosetting monomer to create a co-cured layered material which is processed with either a thermoset adhesive or bonded by fusion.

U.S. Pat. No. 6,137,093 discloses high efficiency heating agents that consist of ferromagnetic fibers for use in alternating magnetic fields.

### SUMMARY OF THE INVENTION

Accordingly, it is an object of the present invention to provide an improved resin composition comprised of a resin matrix made from conductive or magnetic particles and a fabricated inductive responsive sheet, which form a dual susceptor composition. The dual susceptor composition heats quickly using a low electrical induction energy frequency.

As is known, induction heating technologies are utilized to weld, forge, bond or set polymer materials using fixed time duration (on/off) from an electrical energy induction source. The present invention provides a new resin fusion composition for induction bonding. The dual susceptor resin composition of the present invention provides high efficiency monolithic fusion induction heating with minimal power loss. The invention also deals with a method for controlled temperature induction heating using the dual susceptor composition in which the time of the electrical induction energy is varied using pulse width modulated variable time cycles.

Control of the heating of the dual susceptor composition using the variable inductive magnetic field is from heat generated by conductive or magnetic materials which are used to laminate or encapsulate an electro-magnetic sheet structure. These inductive materials are joined in a resin compatible matrix that reacts to the induction energy modulation. The inventive energy efficient dual susceptor heats quickly in the induction field at a specified temperature or temperature profile based on the amount of inductive energy delivered.

The induction heat that is generated through hysteresis loss ceases from ferromagnetic materials or eddy currents (skin effect) of nonmagnetic or electrically conductive materials. The invention is applicable to bonding thermoplastic materials or thermoset composites and curing thermoset adhesives using inductive particles compounded in composite resins or polymers which are utilized to laminate or encapsulate a woven, non-woven or perforated inductive sheet material structure, and the time cycle pulsing of the electrical induction energy.

The inventive dual susceptor composition begins with nano sized structures to micron sized inductive materials coated with a specified polymer or thermoset material and compounded into a resin matrix. The resin matrix is applied in a wetted state and then used to laminate or encapsulate a woven, non-woven or perorated inductive material structure to form the dual susceptor inductive heating composition.

Non-woven inductive heating materials are manufactured by putting small fibers together in the form of a structure (sheet or web) and then binding them either mechanically by applying a polymer or surface tension binder and then melting the binder in the web or during the resin matrix lamination or encapsulation process.

Woven inductive heating materials are a conductive and magnetic material structured cloth or mesh formed by weaving. The inductive woven cloth is laminated or encapsulated using the resin matrix.

Finally, perforated inductive heating materials are fabricated from a solid profile. The conductive and magnetic material structure is laminated or encapsulated using the resin matrix.

Pursuant to the inventive method, the composition is rapidly heated by an electro-magnetic precision rapid heating with variable induction time using electrical induction energy frequency at a fixed KHz to MHz single frequency which is pulse width modulated through variable time cycles, thereby creating a precision electromagnetic heating process. The efficient electrical energy transfer into inductive heating is controlled through total energy absorbed by the dual susceptor composition over time.

Other features and advantages of the present invention will become apparent from the following description of the invention.

### BRIEF DESCRIPTION OF THE DRAWING

FIG. 1 is a schematic illustration showing the resin matrix and inductive material structure;

FIG. 2 is a schematic showing the laminate or encapsulate pursuant to the invention; and

FIG. 3 is a schematic showing equipment for carrying out bonding using the inventive dual susceptor composition.

### DETAILED DESCRIPTION OF THE INVENTION

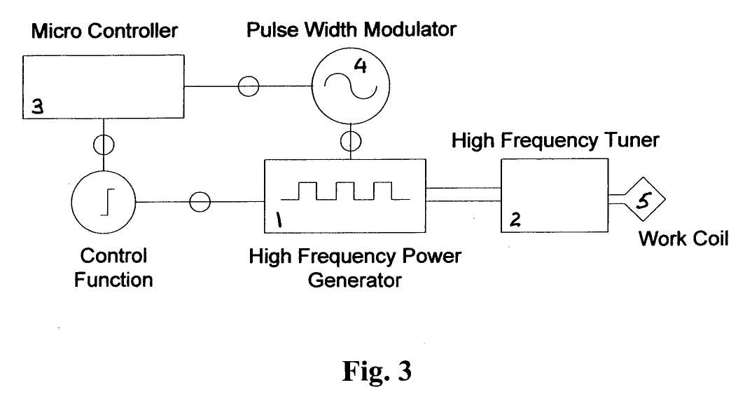

FIG. 3 shows a high frequency match impedance tuner 1 and a generator 2 that receives desired inductive heat response commands from control signals generated by a microcontroller 3 for a desired inductive energy response. Each control signal represents a desired time frequency and desired duty cycle. The high frequency power circuit receives the control signals 4 and generates fixed or variable frequency pulse width modulation signals in response. Each frequency pulse width modulated signal has one of at least two fixed frequencies corresponding to the desired magnetic heat effect and has one of a plurality of active duty cycles corresponding to the desired duty cycle to achieve the level of inductive power to control the heating of electrically conductive and magnetic particles. The duty cycles can range from 0 to 100%.

The magnetic field work coil 5 receives the fixed or variable frequency pulse width modulated signals from the high frequency power generator circuit to control the magnetic field flux density of the work coil 5.

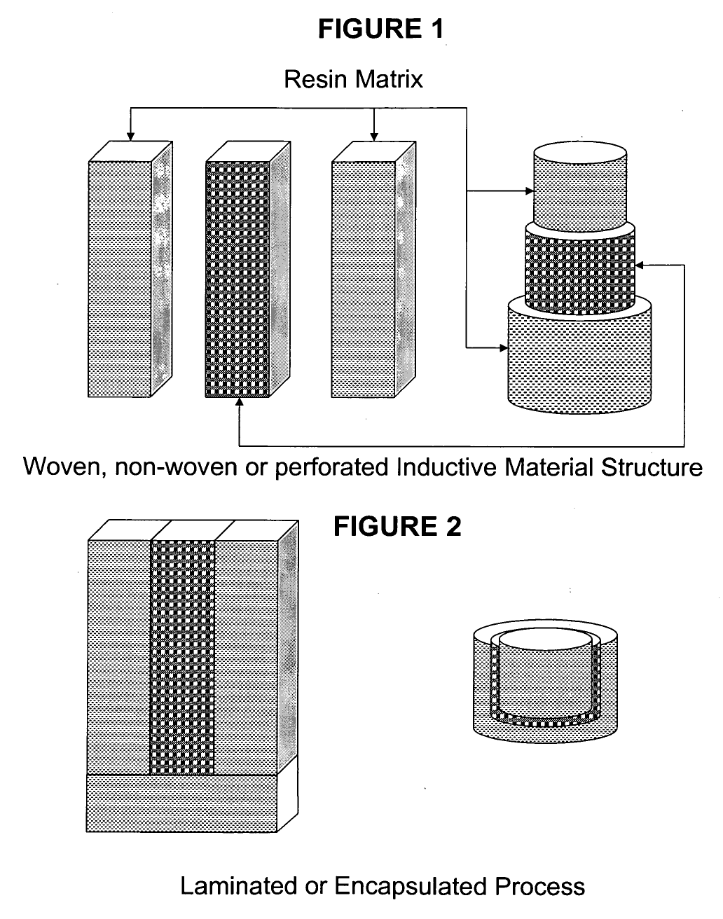

The dual susceptor composition for controlling temperature induction heating is made up of at least one polymer or thermoset material and magnetic or electrically conductive particles. The particles are greater than or equal to about 10 nanometers. The polymer or thermoset material and the magnetic or electrically conductive particles form a resin matrix that laminates or encapsulates a woven, non-woven or perforated inductive material structure (See FIGS. 1 and 2).

When heated, the resin matrix and the dual susceptor composition melt to flow and provide shear strength, resulting in a permanent monolithic fusion joint.

The woven, non-woven or perforated inductive material structure is electrically conductive and magnetically responsive at a high frequency generator power output. The power output is supplied by a high frequency power circuit that receives control signals and generates fixed or variable pulse width modulation signals in response to the control signals. The control signals are provided by a high frequency match impedance controller. A generator of the power circuit receives desired inductive heat response commands from generated control signals for desired inductive energy response, where as each control signal represents a desired time frequency and a desired duty cycle. Each frequency pulse width modulated signal has one of at least two fixed frequencies corresponding to the desired magnetic heat effect and has one of a plurality of active duty cycles corresponding to the desired duty cycle to achieve the level of inductive power to control the heating of the dual susceptor composition. Duty cycles can be from 0-100% (See FIG. 3).

A magnetic field work coil receives the fixed or variable frequency pulse width modulated signals from the high frequency power generator circuit to control the magnetic field flux density of the work coil. The high frequency power generator circuit operates in a range from 5 KHz to 30 MHz.

In one embodiment of the invention, the electrically conductive and magnetic particles are evenly distributed in the resin matrix used for laminating or encapsulating the inductive material structure to form the dual susceptor composition.

In another embodiment, the resin matrix is applied in a wetted state and then used to laminate or encapsulate a woven, non-woven or perforated inductive material structure.

The resin matrix can be heated to a wetted state and then used to laminate or encapsulate the non-woven material so as to bind the non-woven structure through heat transfer, and thereby form the dual susceptor inductive heating composition.

When the resin matrix is applied and then used to laminate or encapsulate a woven or perforated inductive material structure, the resin matrix is bound by surface tension on the structure during the joining process.

It is understood that the inventive dual susceptor inductive heating composition can be one or multiples of laminations or encapsulations.

The polymer or thermoset composition has the electrically conductive and magnetic particles present from about 1% to about 75% or greater by weight depending on the base polymer reaction or thermoset reaction for processing into the inductive material structure to form the dual susceptor composition.

And still a further embodiment of the invention the polymer composition has a resin matrix material comprised of a thermoplastic material.

The thermoplastic material can be acrylonitrile butadiene styrene, poly(etheretherketone), polyetherketoneketone, poly(etherimide), polyphenylene sulfide, poly(sulfone), polyethylene terephthalate, polyester, polyamide, polypropylene, polyurethane, polyphenylene oxide, polycarbonate, polyvinylchloride, polyphenylene ether, polypropylene/polyamide, polypropylene/ethylene vinyl alcohol, polyethylene, or combinations thereof.

In a further embodiment of the dual susceptor composition, the Curie temperature (Tc) is greater than the melting temperature of the polymer matrix material.

Furthermore, the Curie temperature (Tc) of the composition is greater than the curing temperature of the thermoset composition material.

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. A dual susceptor composition, comprising a resin matrix formed of at least one polymer or thermoset material and magnetic or electrically conductive particles; an inductive material structure laminated with or encapsulated by the resin matrix.

2. The dual susceptor composition according to claim 1, wherein the particles are greater than or equal to about 10 nanometers in size.

3. The dual susceptor composition according to claim 1, wherein the particles are present from about 1% to about 75% by weight.

4. The dual susceptor composition according to claim 1, wherein the resin matrix comprises a thermoplastic material.

5. The dual susceptor composition according to claim 4, wherein the thermoplastic material is selected from the group consisting of:
acrylonitrile butadiene styrene, poly(etheretherketone), polyetherketoneketone, poly(etherimide), polyphenylene sulfide, poly(sulfone), polyethylene terephthalate, polyester, polyamide, polypropylene, polyurethane, polyphenylene oxide, polycarbonate, polyvinylchloride, polyphenylene ether, polypropylene/polyamide, polypropylene/ethylene vinyl alcohol, polyethylene, or combinations thereof.

6. The dual susceptor composition according to claim 1, wherein the particles have a Curie temperature that is greater than a melting temperature of matrix polymer material.

7. The dual susceptor composition according to claim 1, herein the particles have a Curie temperature that is greater than a curing temperature of the matrix thermoset material.

8. The dual susceptor composition according to claim 1, wherein the inductive material structure is a woven, non-woven or perforated material.

9. The dual susceptor composition according to claim 1, wherein the particles are evenly distributed in the resin matrix.

10. The dual susceptor composition according to claim 8, wherein the inductive material structure is electrically conductive and magnetically responsive at a high frequency generator output.

11. A method for controlling temperature induction heating, comprising the steps of:
providing an inductive material structure;
laminating or encapsulating the inductive material structure with a resin matrix formed of at least one polymer or thermoset material and magnetic or electrically conductive particles to form a dual susceptor composition;
heating the composition with an electrical induction energy frequency at a fixed frequency; and
pulse width modulating the frequency through variable time cycles.

12. The method according to claim 11, wherein the frequency is in a range of 5 KHz to 30 MHz.

13. The dual susceptor composition according to claim 11, wherein the resin matrix is applied in a wetted state to laminate or encapsulate the inductive material structure.

14. The method according to claim 11, wherein the inductive structure is a non-woven material, the resin matrix is heated to a wetted state and laminates or encapsulates the non-woven material so as to bind the non-woven structure by heat transfer.

15. The method according to claim 11, wherein the inductive structure is a woven or perforated material, the resin matrix being laminated to or encapsulating the inductive structure so that the resin matrix is bound by on the structure by surface tension.
